(19) United States
(12) Patent Application Publication
(10) Pub. No.: US 2026/0220177 A1
(43) Pub. Date: Jul. 30, 2026

(54) QUERY DRAFTING VIA MACHINE LEARNING MODELS

(71) Applicant: Disney Enterprises, Inc., Burbank, CA (US)

(72) Inventors: Tyler PAYNE, Los Angeles, CA (US); Ella E. LUCAS, Los Angeles, CA (US); Andrew M. WRIGHT, Irvine, CA (US); John J. WISEMAN, Burbank, CA (US); Xavier MALINA, Burbank, CA (US); James R. KENNEDY, Glendale, CA (US)

(21) Appl. No.: 19/036,853

(22) Filed: Jan. 24, 2025

(51) Int. Cl. G06F 16/334; G06F 16/22; G06F 16/332

(52) U.S. Cl. CPC G06F 16/334; G06F 16/2237; G06F 16/332

(57) ABSTRACT

Techniques for machine learning-based database querying are provided. A natural language request for information contained in a database is received. Based on the natural language request and a natural language meta-schema for the database, a relevant schema comprising at least one of a subset of tables from a plurality of tables of the database, a subset of columns from a plurality of columns in the plurality of tables, or a subset of values from a plurality of values in the plurality of columns is identified. A database query is generated based on prompting one or more language models (LMs) using the relevant schema and the natural language request. A result from the database is retrieved using the database query, and a natural language response to the natural language request is generated based on the result and using the one or more LMs.

### BACKGROUND

In a wide variety of environments, many projects and processes begin with (or at least can benefit from) evaluating comparable historical information from prior projects or processes. For example, when starting work on designing a new system (e.g., automobiles, aircraft, computing deployments, and the like), it may be beneficial to review prior information about the design and/or development of prior comparable systems. In many cases, records of such information are stored in structured databases, thereby relying on technical expertise in the structured query language(s) and database schema(s) to access and analyze the relevant data. Though making the data accessible through less complex means (e.g., via natural language requests) would be advantageous, existing approaches fail to provide adequate access without also introducing high failure rates and concerns relating to hallucination or inaccurate output.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts an example computing environment for query drafting and response generation using machine learning models, according to some embodiments of the present disclosure.

FIG. 2 depicts an example workflow for query drafting and response generation using machine learning models, according to some embodiments of the present disclosure.

FIG. 3 is a flow diagram depicting an example method for creating meta-schemas to facilitate query drafting using machine learning models, according to some embodiments of the present disclosure.

FIG. 4 is a flow diagram depicting an example method for query drafting and response generation using machine learning models, according to some embodiments of the present disclosure.

FIG. 5 is a flow diagram depicting an example method for response generation using machine learning, according to some embodiments of the present disclosure.

FIG. 6 depicts an example computing device configured to perform various embodiments of the present disclosure.

### DETAILED DESCRIPTION

In some embodiments of the present disclosure, techniques are provided to enable improved query drafting and response generation from structured databases using machine learning model(s).

In some aspects, machine learning models can be trained and used to facilitate or provide more direct access to data stored in structured databases using unstructured (e.g., natural language) requests. This can not only accelerate design and development processes relying on such historical data (which may therefore reduce the expense and effort of the design process), but can also significantly improve data access with reduced computational expense. That is, though vast amounts of data can be effectively stored in structured databases, the structure itself (which is so useful for effective storage) also serves as an inherent barrier to easy data access. Further, embodiments of the present disclosure provide improved data accessibility without relying on deep structural understanding by users. For example, the generation and use of meta-schemas to facilitate or improve the query drafting ability of machine learning models can enable improved data access using unstructured inputs (e.g., more accurate, less computationally expense, and/or faster).

Some efforts have been made to use language models (LMs), such as large language models (LLMs), to improve data search, such as by allowing users to interact with structured databases in a more unstructured and conversational manner, asking complex questions and receiving relevant answers without relying on the user understanding the underlying structures or query language(s). However, while some recent approaches have yielded impressive results, many challenges remain unsolved. As one example, when dealing with the large quantities of data that often arise in complex database schemas commonly in use today, existing approaches exhibit unacceptably high failure rates. For example, when prompted with too much information, existing models often fail to respond appropriately due to “losing” context (e.g., selectively ignoring information in the middle of the prompt). Similarly, existing approaches often suffer reduced accuracy while incurring significantly increased latency for such long prompts. Moreover, it is well documented that LLM-based systems often “hallucinate,” generating output that is inaccurate and/or has no basis in reality.

In some embodiments of the present disclosure, to enable more accurate and reliable data access with reduced computational expense, a meta-schema can be generated describing the various components of the database(s) (e.g., the tables of one or more database(s) and/or the columns of each table) using unstructured text (e.g., natural language). For example, a relatively short natural language label (e.g., one or two sentences) may be used to describe the contents and/or purpose of each table and/or column in the database. Further, in some embodiments, one or more semantic indices can be generated for each column (e.g., by vectorising some or all of the values or rows of the column), enabling scalable and intelligent retrieval of semantically relevant rows.

In some embodiments, when a runtime request is received, the system may use the meta-schema labels and/or vectorized semantic indices to rapidly identify relevant table(s), column(s), and/or value(s) for the request, as discussed in more detail below. In some embodiments, this initial filtration and/or vector searching can be performed in a highly parallelized manner (e.g., evaluating the relevancy of each table and/or column in parallel), substantially reducing the latency of the relevancy determinations. Further, in some embodiments, this identified subset of the database(s) (referred to in some aspects as the relevant schema) can be used to prompt the query generation process. Advantageously, this reduces the amount of data that the model must consider to generate queries, and further improves model accuracy by providing relevant context directly in the prompt.

In some embodiments, language models can then be used to generate structured queries in the relevant query language(s) based on the input request and the determined relevant schema(s). In some embodiments, the system may further be configured to catch any database query execution errors (e.g., caused by malformed queries). For example, the system may detect any execution errors, and may automatically prompt the model to generate a revised query (e.g., using the error and/or malformed query as input). This may substantially improve the reliability of the system.

In some embodiments, few-shot exemplars may be curated and used to further improve the querying process. For example, prior inputs and corresponding (desired) database queries may be stored. During runtime, the system may fetch one or more of these examples that are most similar to the current input request, inserting he corresponding query into the current prompt for the query-generation machine learning model. This can enable the system to steer the model output and reduce failures.

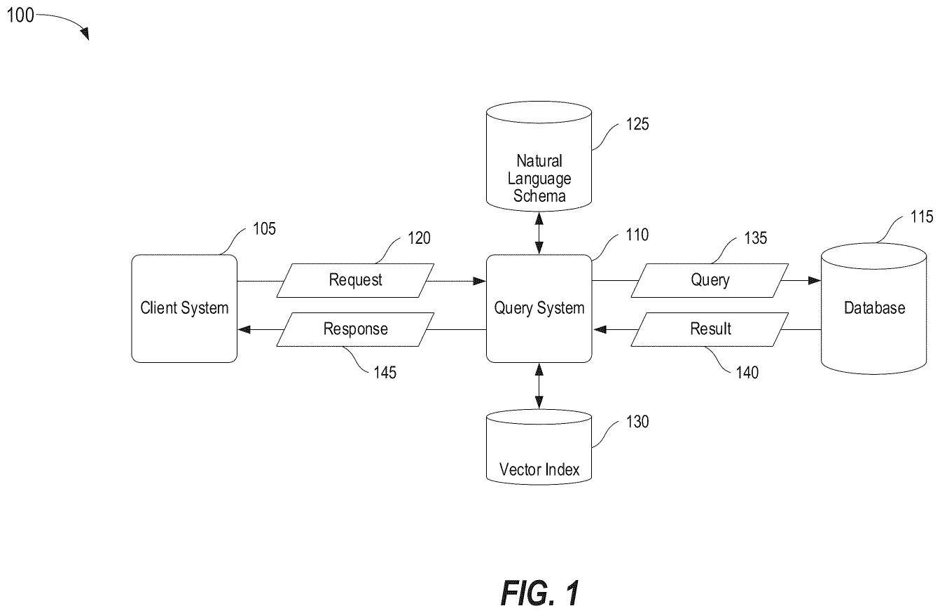

FIG. 1 depicts an example computing environment 100 for query drafting and response generation using machine learning models, according to some embodiments of the present disclosure.

In the illustrated environment 100, a client system 105, a query system 110, and a database 115 are communicatively coupled. Although depicted as discrete systems for conceptual clarity, in some aspects, some or all of the depicted components may be integrated into one or more larger systems, and each may generally be implemented using hardware, software, or a combination of hardware and software. Generally, the client system 105, query system 110, and database 115 may be communicatively coupled using any suitable combination of one or more links, including wired links and/or wireless links. For example in some embodiments, the client system 105 is connected to the query system 110 via a network such as the Internet, and the database 115 and the query system 110 are coupled via a wired connection (such as a local wired network in a cloud system).

In the illustrated example, the client system 105 is generally representative of any computing system that can be used to generate and/or provide input requests (e.g., the request 120) to the query system 110, and/or to receive, process, output, or take some other action based on the resulting responses (e.g., the response 145), as discussed in more detail below. For example, the client system 105 may correspond to a user terminal, allowing users to author requests 120 in order to receive relevant responses 145. Similarly, the query system 110 is generally representative of any computing system that can be used to process requests 120 to generate corresponding structured queries (e.g., the query 135) and/or to process database output (e.g., the results 140) to generate corresponding responses 145, as discussed in more detail below.

In some embodiments, the request 120 comprises unstructured input, such as natural language. For example, the request 120 may include natural language text, spoken natural language (e.g., as an audio file), and the like. In some embodiments, the request 120 comprises a request for data or historical information (e.g., from the database 115). For example, if the user is beginning work on a new hardware design (e.g., a new processing unit for mobile devices), the user may wish to review documentation regarding the initial design decisions of predecessor devices. Accordingly, the request 120 may include natural language questions such as “what instruction set do recent processing units use?”, “how large of a cache do modern processing units rely on?”, or “how to determine the most optimal clock speed?”

Of course, these are simply examples and are not intended to be limiting on aspects of the present disclosure. Generally, the requests 120 may relate to any technology or ecosystem, such as hardware design, software design, robotic and/or animatronic design, theme park ride design (e.g., roller coasters, water rides, and the like), architecture or building design, and the like. As discussed above, the unstructured nature of the request 120 can allow users with little or no technical knowledge to readily request information from the database 115 without the need to understand the actual database schema or structure.

In the illustrated example, the query system 110 receives the (unstructured) request 120 and generates one or more corresponding (structured) queries 135. In some embodiments, the query system 110 uses one or more machine learning models (e.g., LMs and/or LLMs) to generate the query 135. In some embodiments, as discussed above, the query system 110 may utilize various other data, such as the natural language schema 125 (referred to in some aspects as a meta-schema) and/or vector index 130 (referred to in some aspects as a semantic index) to facilitate improved generation of the query 135.

In some embodiments, the natural language schema 125 includes an unstructured (e.g., natural language) description (referred to in some aspects as a “label”) for each of one or more components of the database 115. For example, the natural language schema 125 may include a plain language description of each table (e.g., indicating what the table is intended to store or represent), a description of each column in each table (e.g., indicating the type or characteristics of data stored in a given column), and the like. In some embodiments, if the query system 110 interacts with multiple discrete databases 115, the natural language schema 125 may further include a natural language description for each such database 115. For example, in the context of a theme park, one table may include a label such as “this table is used to store information relating to dark rides in the North park” while another table may be labeled “this table is used to store information relating to roller coasters in the East park” and yet another table is labeled “this table is used to store information relating to dark rides in the South park.” As another example, one column of one table may be labeled with a natural language phrase such as “information relating to historical wait times for the queue of various rides” or “information relating to braking systems used by various rides.”

In some embodiments, some or all of the natural language schema 125 may be manually curated (e.g., authored by human individuals). In some embodiments, some or all of the natural language schema 125 may be automatically generated (e.g., using machine learning, such as LM(s), to generate a description based on the name of a given table or column, contents of the given table or column, relationships among tables or columns, and the like).

In some embodiments, the query system 110 may use the natural language schema 125 to identify a relevant schema (e.g., a relevant subset of the database 115) based on each particular input request 120. For example, in some embodiments, the query system 110 may prompt a language model using all or a portion of the request 120, as well as the natural language label of one or more database components, and ask the model to generate an output indicating whether the particular component is relevant to the request 120, as discussed in more detail below.

In some embodiments, the vector index 130 includes vectorized representations of the value(s) included in one or more columns in the database 115 (e.g., the actual data stored in a given row). For example, if a given value at a given row in a given column is a textual string, the vector index 130 may include a vector representation (e.g., using a vector embedding model). As another example, the vector index 130 may generally include any vectorized version of any data, such as images, audio, and the like.

In some embodiments, the query system 110 may use the vector index 130 to identify a relevant subset of data (e.g., from the database 115) based on each particular input request 120. For example, in some embodiments, the query system 110 may vectorize all or a part of the input request 120, and may perform a semantic or vector search (e.g., identifying vector(s) in the vector index 130 that are in proximity to the vectorized request 120, such as the nearest N vectors, or all vectors within a defined distance). These identified vectors may represent the subset of data (e.g., the particular rows or cells), stored in the database 115, that is potentially relevant to the request 120, as discussed in more detail below.

In some embodiments, the query system 110 uses the natural language schema 125 and/or vector index 130 to augment or supplement the query 135. For example, the query system 110 may use the relevant schema and/or values (e.g., the relevant subset of the database 115) as part of the prompt to a LM (e.g., an LLM) to generate the query 135. That is, the query system 110 may limit the query to the particular portion(s) of the database 115 that are determined to be potentially relevant. This can allow the query system 110 to readily scale to large and complex databases 115 without introducing substantial additional latency. That is, rather than blindly querying the entire database 115, the query system 110 can intelligently target the query to a relatively smaller subset of the database 115, as determined using the natural language schema 125 and/or the vector index 130. This can substantially reduce the computational expense of executing the query 135, while further improving the probability that the query 135 returns relevant information.

In some embodiments, the query system 110 can similarly impose restrictions on the allowable operations that can be included in the query 135. For example, the query system 110 may limit the LM(s) to use only operations from a defined set of database operations to search the database (e.g., using operations such as “read” that do not modify the data in the database 115, but not using operations such as “write” or “delete” that can modify the data).

Generally, the query system 110 may use any combination of the request 120, the relevant schema (determined via the natural language schema 125), and/or the relevant fields (determined via the vector index 130) as an input prompt to one or more LMs to generate the one or more queries 135 (e.g., in order to generate a query based on the given request that is limited to the identified subset of the database 115).

Although not depicted in the illustrated example, in some embodiments, the query system 110 may optionally use one or more example prompts to generate the query 135. In some embodiments, the query system 110 may access a repository of example prompts (e.g., previous user requests, resulting LM prompts generated by the query system 110, and/or resulting queries generated by the LM), to steer the database search. For example, based on the current user request 120, the query system 110 may identify example prompts that are similar or related to the current request, and may include these prior prompts or queries as part of the current prompt to the model when generating the query 135.

Further, although not depicted in the illustrated example, in some embodiments, the query system 110 may identify or catch errors generated by execution of the query 135 (e.g., generated by the database 115), and may use these errors to regenerate an updated query. For example, in some embodiments, the query system 110 may append the error (or information gleaned from the error) to the prior prompt in order to generate a new query 135, and may then use this new query 135 to query the database 115 again. In some embodiments, this error catch and retry procedure may be used until an error-free query is executed, or until a defined number of attempts have been made (e.g., returning failure after N errors have been received without generating a successful query).

In the illustrated environment 100, the database 115 returns a result 140 based on the query 135. In some embodiments, the result 140 is generally a structured set of data retrieved from the database 115 based on the query 135. For example, the result 140 may include or indicate various values, rows, fields, cells, or other portions of the database 115 that are responsive to the query 135. In some embodiments, the results 140 may similarly indicate whether one or more portions of the data are “first-order” (e.g., extracted directly from a given field) or “second-order” (e.g., computed based on two or more fields or columns). For example, data such as the date a given ride was opened may be first-order data and the results 140 may indicate the particular field where the data was found, while data such as the average ridership during the first year of a ride may be second-order data and the results 140 may indicate the field(s), row(s), column(s), and/or table(s) from which the relevant data was extracted and how the result was computed.

In some embodiments, the results 140 may include (or may be associated with) a data lineage indicating characteristics about the underlying data itself used to generate the result 140. For example, if the result 140 indicates the column(s) or row(s) used to generate the result 140, the query system 110 may access data lineage indicating when the corresponding field(s) were added or last updated, what entity or user last added or updated the corresponding field(s), and the like. This lineage can help ensure accuracy and reliability of the results 140.

In the illustrated example, the query system 110 can use the result 140 to generate an (unstructured) response 145. As one example, the particular data values in the result 140 may used as an input prompt to one or more LM(s) (e.g., LLM(s)) to generate a natural language response 145. In some embodiments, all or a portion of the request 120 may also be used as part of this prompt. For example, the prompt used to generate the response 145 may include the request 120 (such as “when was the first dark ride opened in the West park?”) as well as the result 140 (e.g., stating what the first dark ride was, and when it was opened). The resulting response 145 may be natural language (e.g., conversational) text, such as “The first dark ride in the West park was opened in 2016”).

In some embodiments, if the query executed successfully but no data was found (e.g., the result 140 is blank or empty), the generated response 145 may reflect this lack of data. For example, the response 145 may include text such as “We ran a search for indoor roller coasters at our park in Antarctica, but no relevant data was found.”

In some embodiments, the data lineage associated with the results 140 may be used to augment and/or generate the response 145. For example, in some embodiments, the response 145 may be output by the client system 105 (e.g., via a display, such as a chat interface), and the user may mouse over or select all or a portion of the response 145 to cause the relevant lineage to be displayed (e.g., causing a pop up to appear, noting whether the result is first-order or computed data, what user(s) contributed the data, when the data was first uploaded and/or last modified in the database 115, and the like).

As illustrated, the environment 100 generally enables conversational data access, allowing users to use unstructured natural language to efficiently retrieve relevant information from structured database(s) 115, which may be vast and complex, with reduced latency and/or improved result accuracy.

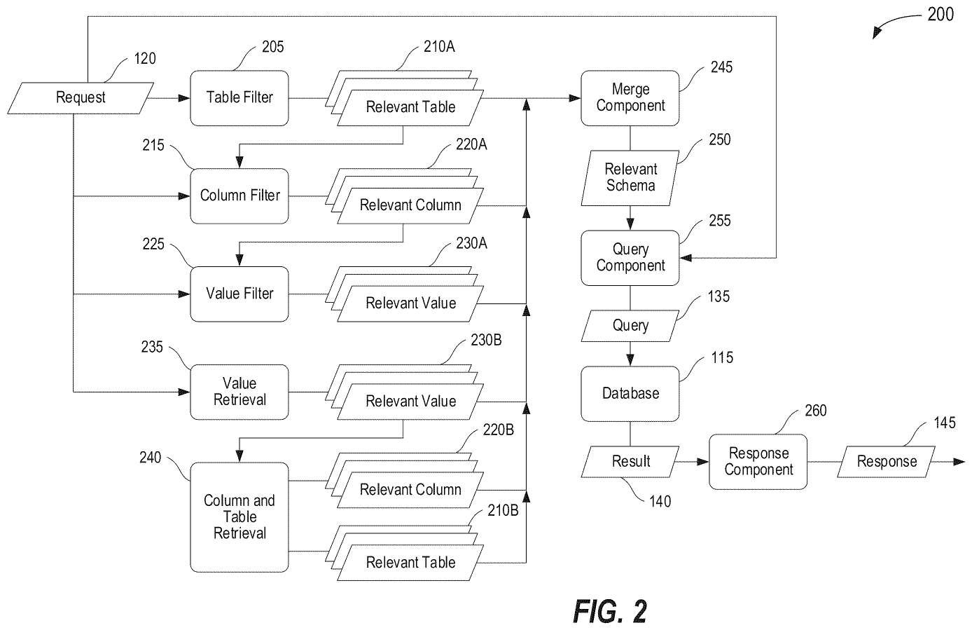

FIG. 2 depicts an example workflow 200 for query drafting and response generation using machine learning models, according to some embodiments of the present disclosure. In some aspects, the workflow 200 is performed by a query system, such as the query system 110 of FIG. 1.

As illustrated, a request 120 (e.g., a natural language question) is accessed by various components, including a table filter 205, a column filter 215, a value filter 225, and a value retrieval 235. In some embodiments, the filtering workflow (e.g., the table filter 205, the column filter 215, and the value filter 225) may be referred to as the “top-down” search or pipeline, while the retrieval workflow (e.g., the value retrieval 235 and column and table retrieval 240) may be referred to as the “bottom-up” search or pipeline.

As illustrated, the table filter 205 may use a meta-schema for the database (e.g., the natural language schema 125 of FIG. 1) to identify (e.g., filter) a set of relevant tables 210A from the database. For example, as discussed above, the table filter 205 may compare all or a portion of the request 120 with the corresponding natural language labels of the tables in the database to determine the set of (potentially) relevant tables 210A. In some embodiments, the table filter 205 uses one or more LMs, such as by providing all or a portion of the request 120 and all or a portion of the natural language table description for a given table as input to the model, and asking the model to predict whether the table is relevant to the request 120. In some embodiments, the table filter 205 prompts the model(s) separately for each table in the database (e.g., asking whether each is relevant in turn). In some embodiments, to accelerate runtime, the table filter 205 may query the model regarding the relevancy of one or more tables entirely or partially in parallel (e.g., across multiple processing cores), allowing the table filter 205 to efficiently scale to large database schemas (with many tables).

In the illustrated example, the column filter 215 may similarly use the meta-schema for the database to identify (e.g., filter) a set of relevant columns 220A from the database. More specifically, in the illustrated example, the column filter 215 may evaluate only those columns included in an identified relevant table 210A. This further reduces the universe of alternatives to be evaluated, which can substantially reduce the latency of the filtering. For example, as discussed above, the column filter 215 may compare all or a portion of the request 120 with the corresponding natural language labels of the column(s) in relevant table(s) 210A to determine the set of (potentially) relevant columns 220A. In some embodiments, the column filter 215 uses one or more LMs, such as by providing all or a portion of the request 120 and all or a portion of the natural language column description for a given column as input to the model, and asking the model to predict whether the column is relevant to the request 120. In some embodiments, the column filter 215 prompts the model(s) separately for each column in the database (e.g., asking whether each is relevant in turn). In some embodiments, to accelerate runtime, the column filter 215 may query the model regarding the relevancy of one or more columns entirely or partially in parallel (e.g., across multiple processing cores), allowing the column filter 215 to efficiently scale to large database tables (with many columns).

In the illustrated example, the value filter 225 may use a vector index (e.g., the vector index 130 of FIG. 1) for the database to identify (e.g., filter) a set of relevant values 230A from the database. More specifically, in the illustrated example, the value filter 225 may evaluate only those values (e.g., rows) included in an identified relevant column 220A. This further reduces the universe of alternatives to be evaluated, which can substantially reduce the latency of the filtering. For example, as discussed above, the value filter 225 may vectorize all or a portion of the request 120, and search the vector index (or the relevant subset thereof, such as the vector indices for relevant columns 220A) to determine the set of (potentially) relevant values 230A (e.g., relevant rows).

In some embodiments, the value filter 225 identifies not only identical terms (e.g., matching vectors), but also terms with semantically similar meaning (as indicated by distance in the vector space). For example, if the request mentions a park in “the North,” the value filter 225 may identify, from the vector index, fields that relate to “Northwest” (as the vector for “North” is likely to be quite close to the vector for “Northwest” in the vector space). Similarly, if the request mentions data from “Southern,” the value filter 225 may identify fields relating to “Southwest” and “Southeast” as relevant.

In some embodiments, the value filter 225 evaluates each column in the relevant columns 220A separately. In some embodiments, to accelerate runtime, the value filter 225 may search the relevant vector space of one or more columns entirely or partially in parallel (e.g., across multiple processing cores), allowing the value filter 225 to efficiently scale to large database tables (with many columns).

In the illustrated workflow 200, the value retrieval 235 may use the request 120 to identify relevant values 230B more directly, as compared to the value filter 225. In some embodiments, while the top-down filtering approach is useful to identify relevant data that is not a precise match, a bottom-up retrieval approach may be useful to identify relevant data that is not readily identified via top-down vector search (and vice versa).

For example, the top-down filtering may efficiently identify relevant but non-identical information (e.g., identifying information for “West park” when the request mentions “Northwestern”). However, purely a bottom-up approach for a request that includes “Northwestern” will likely fail to identify a wide set of relevant information, as many of the fields may include “West” rather than “Northwestern.” Similarly, while the bottom-up retrieval may efficiently identify identical information (e.g., identifying data for a specific codename or unique identifier such as “AH1594,” such as beginning by identifying fields that match “AH1594”), a top-down approach may be unlikely to surface relevant data for such a request (e.g., because no particular table or column is likely to be near “AH1594” in the vector space, unless the table itself has that name). In this way, the top-down and bottom-up searches can be seen as complementary approaches to ensure that the relevant information is efficiently and accurately found.

In the illustrated workflow 200, the value retrieval 235 returns a set of relevant values 230B (e.g., fields or cells in the database that match all or a part of the request 120). Further, as illustrated, the column and table retrieval 240 can use the identified relevant values 230B to identify the corresponding relevant columns 220B (e.g., the columns in the database that include the identified relevant values 230B) and relevant tables 210B (e.g., the tables that include the identified relevant columns 220B).

As illustrated, the relevant tables 210A and 210B, relevant columns 220A and 220B, and/or relevant values 230A and 230B are accessed by a merge component 245, which generates a relevant schema 250. For example, the relevant schema 250 may include or specify some or all of the relevant tables 210A and 210B, some or all of the relevant columns 220A and 220B within these tables, and/or some or all of the relevant values 230A and 230B within these columns. That is, the relevant schema 250 may include one or more of (i) the relevant tables 210A, the relevant tables 210B, the relevant columns 220A, the relevant columns 220B, the relevant values 230A, or the relevant values 230B. In some embodiments, as discussed above, this relevant schema 250 can therefore efficiently represent or indicate the universe of “relevant” information for the request 120 (from a broader system of one or more databases). This allows the request 120 to be executed efficiently (e.g., with low latency), even as the size and/or complexity of the database(s) increases.

In the workflow 200, the relevant schema 250 and the request 120 are accessed by a query component 255, which generates the query 135. In some embodiments, as discussed above, the query component 255 may use one or more machine learning models (e.g., LMs or LLMs) to process the request 120 and relevant schema 250 as input, prompting the model to generate an output query 135. In some embodiments, as discussed above, the query component 255 may constrain the query 135 to an allowable set of operations (e.g., read-only operations) in the database.

As illustrated, the query 135 is used to query a structured database 115, which returns results 140. Although not depicted in the illustrated example, in some embodiments, the workflow 200 may include catching error(s) from the database 115 and generating updated queries based on the errors, allowing the query component 255 to generate better and more accurate queries.

In the workflow 200, the result 140 is then processed using a response component 260 to generate a response 145. In some embodiments, as discussed above, the response component 260 may use one or more machine learning models (e.g., LMs or LLMs) to process the result 140 as input, prompting the model to generate the response 145. In some embodiments, the response component 260 may use the same set of model(s) as the query component 255, or may use a separate set of model(s). Similarly, in some embodiments, the model(s) used by the query component 255 and the response component 260 may be the same models, or may be different models, from those used by the table filter 205 and/or column filter 215.

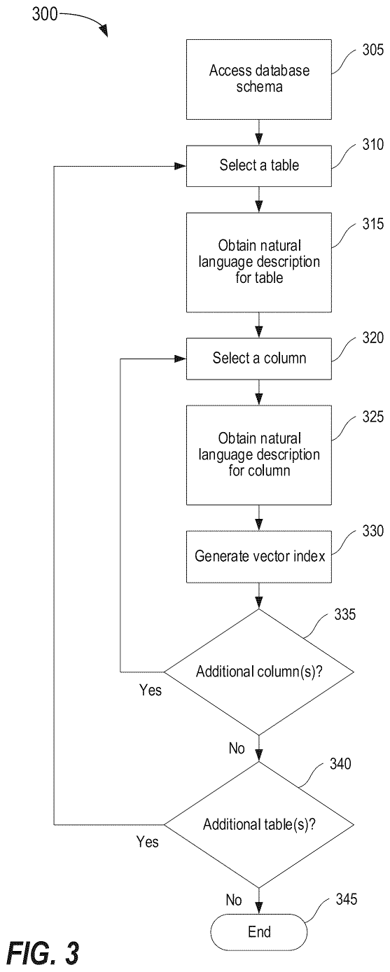

FIG. 3 is a flow diagram depicting an example method 300 for creating meta-schemas to facilitate query drafting using machine learning models, according to some embodiments of the present disclosure. In some embodiments, the method 300 is performed by a query system, such as the query system 110 of FIG. 1 and/or the query system discussed above with reference to FIG. 2. In some embodiments, the method 300 is used to generate meta-schemas (such as the natural language schema 125 of FIG. 1) and/or vector indices (such as the vector index 130 of FIG. 1).

At block 305, the query system accesses a database schema for a database (e.g., the database 115 of FIGS. 1-2). As used herein, “accessing” data may generally include receiving, requesting, retrieving, obtaining, collecting, measuring, generating, or otherwise gaining access to the data. For example, the query system may access the database schema directly or indirectly from an administrator or data engineer. The database schema may generally indicate the various tables in the database, columns in each table, relationships among tables and/or columns, and the like. In some embodiments, the database schema indicates the structure of the database without including specific values or data stored within the database. In some embodiments, the database schema may include at least some data, such as a few example rows for each table (e.g., indicating what a sample row of data looks like, what type of data it contains, and the like). In some embodiments, the database schema may indicate names or labels for each component (e.g., table names, column names, and the like). These names may or may not be natural language, and may not be particularly informative. For example, one table may be named “NorthAttractions.”

At block 310, the query system selects a table from the database schema. Generally, the query system may use a variety of operations to select the table, including randomly or pseudo-randomly, as the query system will process each table in the schema during the method 300.

At block 315, the query system obtains a natural language description for the selected table. In some embodiments, as discussed above, the query system may obtain some (or all) of the natural language descriptions from a user (e.g., a data scientist). For example, an individual may author a label such as “information relating to roller coasters, dark rides, water rides, character meetings, and events in the North park.” In some embodiments, as discussed above, the query system may obtain some (or all) of the natural language descriptions by automatically generating the description(s). For example, the query system may use a machine learning model to process data such as the current title of the table (e.g., “NorthAttractions”), the names of columns in the table, the data types stored in each column, and/or one or more example rows of data from the table, prompting the model to generate a natural language summary or label for the table.

At block 320, the query system selects a column from the selected table (as reflected in the database schema). Generally, the query system may use a variety of operations to select the column, including randomly or pseudo-randomly, as the query system will process each column in the table during the method 300.

At block 325, the query system obtains a natural language description for the selected column. In some embodiments, as discussed above, the query system may obtain some (or all) of the natural language descriptions from a user (e.g., a data scientist). For example, an individual may author a label such as “data related to occurrence of maintenance events for park attractions, such as durations, costs, causes, and solutions.” In some embodiments, as discussed above, the query system may obtain some (or all) of the natural language descriptions by automatically generating the description(s). For example, the query system may use a machine learning model to process data such as the title of the selected table, the name of the selected column and/or one or more other columns in the table, the data types stored in the selected column, and/or one or more example data values from the column, prompting the model to generate a natural language summary or label for the column.

At block 330, the query system generates a vector index for the selected column. For example, as discussed above, the query system may use various models or other techniques to generate a vector (e.g., a numerical representation) for each entry in the selected column. These numerical representations may enable rapid and efficient search of the column. In some embodiments, the query system may optionally generate an overall vector representation of the column (e.g., based on the vectors indexed therein).

At block 335, the query system determines whether there is at least one additional column remaining, in the selected table, to be processed. If so, the method 300 returns to block 320. If not, the method 300 continues to block 340. Although the illustrated example depicts a sequential process (e.g., selecting and evaluating each column in sequence) for conceptual clarity, in some embodiments, the query system may process some or all of the columns entirely or partially in parallel.

At block 340, the query system determines whether there is at least one additional table remaining, in the database schema, to be processed. If so, the method 300 returns to block 310. If not, the method 300 terminates at block 345. Although the illustrated example depicts a sequential process (e.g., selecting and evaluating each table in sequence) for conceptual clarity, in some embodiments, the query system may process some or all of the tables entirely or partially in parallel.

In these ways, using the method 300, the query system (or another system) can generate a meta-schema (e.g., the natural language schema 125 of FIG. 1) and/or an index of vectors (e.g., the vector index 130 of FIG. 1) to significantly reduce the computational expense and latency of query evaluation during runtime.

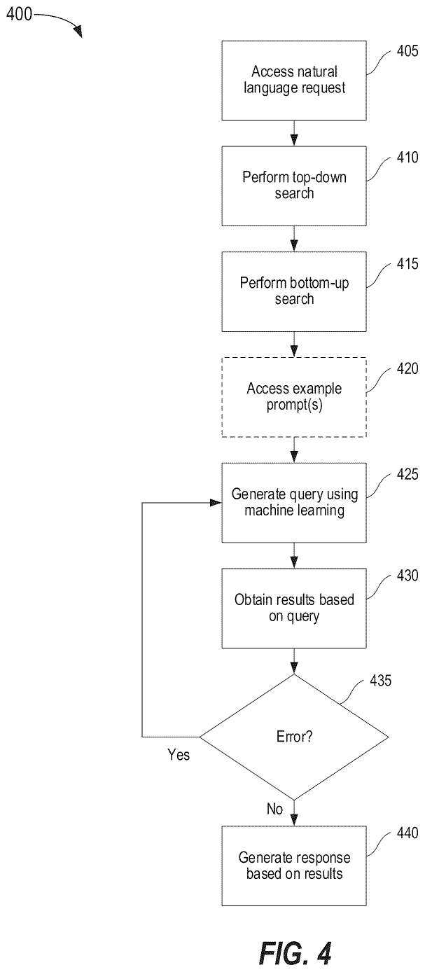

FIG. 4 is a flow diagram depicting an example method 400 for query drafting and response generation using machine learning models, according to some embodiments of the present disclosure. In some embodiments, the method 400 is performed by a query system, such as the query system 110 of FIG. 1 and/or the query systems discussed above with reference to FIGS. 2-3.

At block 405, the query system accesses a natural language request (e.g., the request 120 of FIGS. 1 and/or 2) to obtain or retrieve information from a database. For example, as discussed above, the query system may receive the natural language request from a client system, from a user, from an automated application, and the like. Generally, as discussed above, the request may be unstructured (e.g., conversational language), and may include a question or inquiry to retrieve information from the database and/or to generate an answer to the question based on the information in the database.

At block 410, the query system performs a top-down search of the database using a natural language meta-schema, as discussed above. For example, the query system may evaluate a natural language label of each table (in sequence or in parallel) to identify table(s) that are potentially relevant to the request (e.g., the relevant tables 210A of FIG. 2), such as using one to more machine learning models. The query system may similarly evaluate a natural language label of each column (in the entire database, or in the identified relevant tables) in sequence or in parallel to identify column(s) that are potentially relevant to the request (e.g., the relevant columns 220A of FIG. 2). In some embodiments, as discussed above, the query system may further search a vector index of the database (e.g., across all columns or across the identified relevant columns) based on the request to identify values or rows that are potentially relevant to the request (e.g., the relevant values 230A of FIG. 2).

At block 415, the query system performs a bottom-up search of the database based on the request, as discussed above. For example, the query system may search a vector index of the database (e.g., across all columns and tables) based on the request to identify values or rows that match the all or part of the request (e.g., the relevant values 230B of FIG. 2). The query system may then identify the corresponding column(s) in which these relevant values are stored (e.g., the relevant columns 220B of FIG. 2) and/or the corresponding tables in which the relevant columns are found (e.g., the relevant tables 210B of FIG. 2).

In this way, as discussed above, the query system can efficiently generate a relevant schema (e.g., a subset of the database that is potentially relevant for the particular request).

At block 420, the query system optionally accesses one or more example prompts (which may be user-defined and/or automatically created, as discussed above). For example, each example prompt may indicate a desired or target database query given a particular input request. By searching the example prompts for prior requests that are similar to the current request, the query system can identify corresponding database queries that were used for the prior request and/or that may be useful for the current request.

At block 425, the query system generates a query (e.g., the query 135 of FIGS. 1 and/or 2) using one or more machine learning models. For example, as discussed above, the query system may generate a prompt comprising the request, the relevant schema, and/or the example prompt(s). This prompt may then be processed using the machine learning model to generate an output database prompt for the request. In some embodiments, as discussed above, the prompt generation model may be constrained to only use a subset of operations (e.g., read-only operations).

At block 430, the query system obtains database results (e.g., the results 140 of FIGS. 1 and/or 2) by executing the query (generated at block 430) against the database.

At block 435, the query system determines whether the results include or indicate an error (e.g., caused by a malformed query), such as a misspelled operation, missing brackets or quotation marks, invalid statement orders, and the like. If so, the method 400 returns to block 425, where the query system generates an updated query. In some embodiments, the query system generates the updated query by prepending, appending, or inserting the error message into the model prompt. In some embodiments, as discussed above, the query system may repeat this error correction process until no errors are generated, or until a defined number of attempts have been made.

Returning to block 435, if no errors are reported, the method 400 continues to block 440, where the query system generates a response (e.g., the response 145 of FIGS. 1 and/or 2) based on the database results. For example, as discussed above, the query system may process the results using one or more language models to generate an unstructured and/or natural language response to the input request.

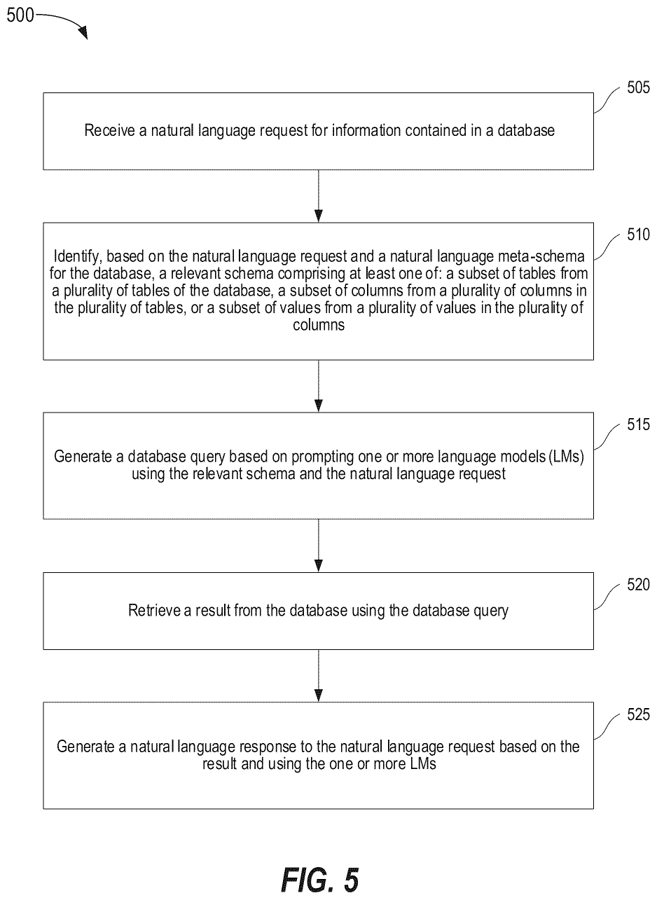

FIG. 5 is a flow diagram depicting an example method 500 for response generation using machine learning, according to some embodiments of the present disclosure. In some embodiments, the method 500 is performed by a query system, such as the query system 110 of FIG. 1 and/or the query systems discussed above with reference to FIGS. 2-4.

At block 505, a natural language request (e.g., the request 120 of FIGS. 1-2) for information contained in a database (e.g., the database 115 of FIGS. 1-2) is received.

At block 510, based on the natural language request and a natural language meta-schema (e.g., the natural language schema 125 of FIG. 1) for the database, a relevant schema (e.g., the relevant schema 250 of FIG. 2) comprising at least one of (i) a subset of tables (e.g., the relevant tables 210A and/or 210B of FIG. 2) from a plurality of tables of the database, (ii) a subset of columns (e.g., the relevant columns 220A and/or 220B of FIG. 2) from a plurality of columns in the plurality of tables, or (iii) a subset of values (e.g., the relevant values 230A and/or 230B of FIG. 2) from a plurality of values in the plurality of columns is identified.

At block 515, a database query (e.g., the query 135 of FIGS. 1-2) is generated based on prompting one or more language models (LMs) using the relevant schema and the natural language request.

At block 520, a result (e.g., the result 140 of FIGS. 1-2) from the database is retrieved using the database query.

At block 525, a natural language response (e.g., the response 145 of FIGS. 1-2) to the natural language request is generated based on the result and using the one or more LMs.

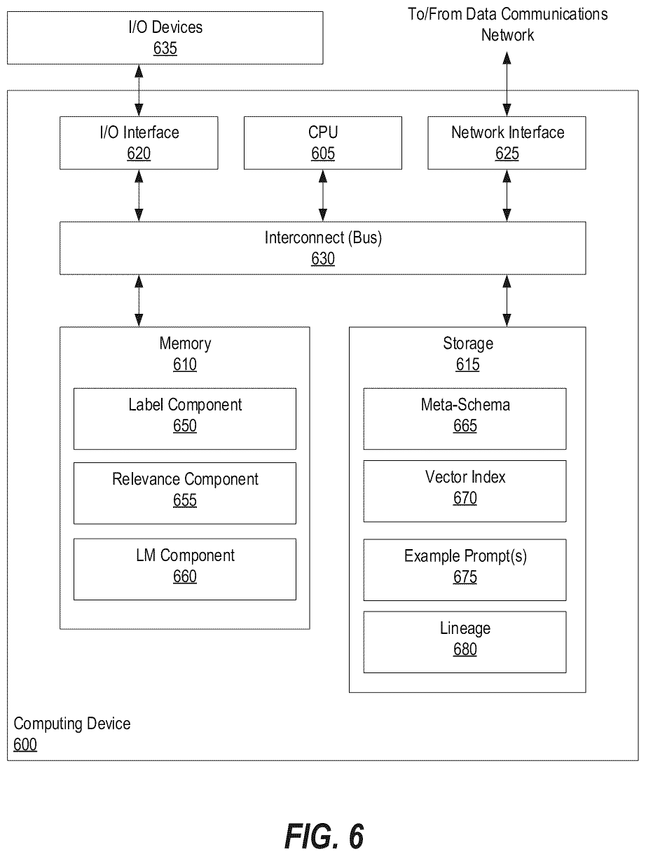

FIG. 6 depicts an example computing device 600 configured to perform various embodiments of the present disclosure. Although depicted as a physical device, in embodiments, the computing device 600 may be implemented using virtual device(s), and/or across a number of devices (e.g., in a cloud environment). In one embodiment, the computing device 600 corresponds to or implements a query system, such as the query system 110 of FIG. 1 and/or the query systems discussed above with reference to FIGS. 2-5.

As illustrated, the computing device 600 includes a CPU 605, memory 610, a network interface 625, and one or more I/O interfaces 620. Though not included in the depicted example, in some embodiments, the computing device 600 also includes one or more storages. In the illustrated embodiment, the CPU 605 retrieves and executes programming instructions stored in memory 610, as well as stores and retrieves application data residing in memory 610 and/or storage (not depicted). The CPU 605 is generally representative of a single CPU and/or GPU, multiple CPUs and/or GPUs, a single CPU and/or GPU having multiple processing cores, and the like. The memory 610 is generally included to be representative of a random access memory. In an embodiment, if storage is present, it may include any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, network interface(s) 625, and I/O interface(s) 620 are communicatively coupled by one or more buses 630.

In the illustrated embodiment, the memory 610 includes a label component 650, a relevance component 655, and a LM component 660, which may perform one or more embodiments discussed above. Although depicted as discrete components for conceptual clarity, in embodiments, the operations of the depicted components (and others not illustrated) may be combined or distributed across any number of components. Further, although depicted as software residing in memory 610, in embodiments, the operations of the depicted components (and others not illustrated) may be implemented using hardware, software, or a combination of hardware and software.

The label component 650 may generally be used to generate or otherwise obtain natural language labels for the various components of a database (e.g., the database 115 of FIGS. 1 and/or 2), as discussed above. For example, the label component 650 may use machine learning to generate an unstructured natural language text description of each table and column in the database, allowing a meta-schema (e.g., the natural language schema 125 of FIG. 1) to be generated. In some embodiments, the label component 650 may additionally or alternatively be used to generate vector indices (e.g., the vector index 130 of FIG. 1) for the database, as discussed above.

The relevance component 655 may generally be used to identify relevant tables, columns, and/or values within the database based on the input requests, as discussed above. For example, the relevance component 655 may evaluate the natural language meta-schema and/or the vector index to identify the relevant subset(s) of the database, such as using a top-down filtering approach and/or a bottom-up retrieval approach.

The LM component 660 may generally be used to process various input prompts to generate corresponding output text, as discussed above. For example, the LM component 660 may generate natural language descriptions of columns and/or rows (e.g., for the meta-schema), may classify or predict the relevance of each table and/or row based on the meta-schema, may generate structured queries for input requests and/or may generate unstructured responses based on database results, as discussed above. Generally, the LM component 660 may use one or more machine learning models (e.g., language models) to perform the various tasks discussed above.

In the illustrated example, the storage 615 includes a meta-schema 665, a vector index 670, a set of example prompt(s) 675, and information on data lineage 680. Although depicted as residing in storage 615, the depicted data may be stored in any suitable location.

Generally, the meta-schema 665 (which may correspond to the natural language schema 125 of FIG. 1) may comprise natural language labels for the components of the database, as discussed above. The vector index 670 (which may correspond to the vector index 130 of FIG. 1) may comprise vectorized representations of the data contained within the database, as discussed above. The example prompt(s) 675 may indicate a desired or appropriate query based on a sample prompt or request, as discussed above. The data lineage 680 may indicate the lineage of one or more data elements in the database, such as when the data was updated, the identity of the user that updated the data, and the like, as discussed above.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

1. A method, comprising:
receiving a natural language request for information contained in a database;
identifying, based on the natural language request and a natural language meta-schema for the database, a relevant schema comprising:
a subset of tables from a plurality of tables of the database, wherein the subset of tables excludes at least one table of the plurality of tables and is identified based on a first plurality of natural language labels for the plurality of tables,
a subset of columns from a plurality of columns in the subset of tables, wherein the subset of columns excludes at least one column of the plurality of columns and is identified based on a second plurality of natural language labels for the plurality of columns, and
a subset of values from a plurality of values in the subset of columns, wherein the subset of values excludes at least one value of the plurality of values and is identified based on semantic indices for the plurality of values;
generating a database query based on prompting one or more language models (LMs) using the relevant schema and the natural language request;
retrieving a result from the database using the database query; and
generating a natural language response to the natural language request based on the result and using the one or more LMs.

2. The method of claim 1, further comprising:
generating the natural language meta-schema based on:
generating the first plurality of natural language labels for the plurality of tables; and
generating the second plurality of natural language labels for the plurality of columns; and
vectorizing the plurality of values to generate the semantic indices.

3. The method of claim 1, wherein identifying the relevant schema comprises:
identifying the subset of tables based on filtering the plurality of tables based on the natural language request;
identifying the subset of columns based on filtering columns from the subset of tables based on the natural language request; and
identifying the subset of values based on filtering values from the subset of columns based on the natural language request.

4. The method of claim 1, wherein identifying the relevant schema comprises:
identifying the subset of values based on identifying values, of the plurality of values, matching the natural language request;
identifying the subset of columns based on identifying columns containing the subset of values; and
identifying the subset of tables based identifying tables containing the subset of columns.

5. The method of claim 1, wherein generating the database query comprises limiting the one or more LMs to use a defined set of database operations to search the relevant schema.

6. The method of claim 1, wherein generating the database query comprises:
retrieving one or more example prompts based on the natural language request; and
prompting the one or more LMs based further on the one or more example prompts.

7. The method of claim 1, wherein retrieving the result from the database using the database query comprises:
receiving an error in response to querying the database using the database query;
generating an updated database query based on prompting the one or more LMs using the relevant schema, the natural language request, and the error; and
retrieving the result from the database based on querying the database using the updated database query.

8. The method of claim 1, wherein generating the natural language response comprises:
generating an indication of one or more columns from which the result was retrieved; and
accessing a data lineage indicating when the result was added to the database.

9. One or more non-transitory computer readable media containing, in any combination, computer program code that, when executed by operation of any combination of one or more processors, performs an operation comprising:
receiving a natural language request for information contained in a database;
identifying, based on the natural language request and a natural language meta-schema for the database, a relevant schema comprising:
a subset of tables from a plurality of tables of the database, wherein the subset of tables excludes at least one table of the plurality of tables and is identified based on a first plurality of natural language labels for the plurality of tables,
a subset of columns from a plurality of columns in the subset of tables, wherein the subset of columns excludes at least one column of the plurality of columns and is identified based on a second plurality of natural language labels for the plurality of columns, and
a subset of values from a plurality of values in the subset of columns, wherein the subset of values excludes at least one value of the plurality of values and is identified based on semantic indices for the plurality of values;
generating a database query based on prompting one or more language models (LMs) using the relevant schema and the natural language request;
retrieving a result from the database using the database query; and
generating a natural language response to the natural language request based on the result and using the one or more LMs.

10. The one or more non-transitory computer readable media of claim 9, further comprising:
generating the natural language meta-schema based on:
generating the first plurality of natural language labels for the plurality of tables; and
generating the second plurality of natural language labels for the plurality of columns; and
vectorizing the plurality of values to generate the semantic indices.

11. The one or more non-transitory computer readable media of claim 9, wherein identifying the relevant schema comprises:
identifying the subset of tables based on filtering the plurality of tables based on the natural language request;
identifying the subset of columns based on filtering columns from the subset of tables based on the natural language request; and
identifying the subset of values based on filtering values from the subset of columns based on the natural language request.

12. The one or more non-transitory computer readable media of claim 9, wherein identifying the relevant schema comprises:
identifying the subset of values based on identifying values, of the plurality of values, matching the natural language request;
identifying the subset of columns based on identifying columns containing the subset of values; and
identifying the subset of tables based identifying tables containing the subset of columns.

13. The one or more non-transitory computer readable media of claim 9, wherein retrieving the result from the database using the database query comprises:
receiving an error in response to querying the database using the database query;
generating an updated database query based on prompting the one or more LMs using the relevant schema, the natural language request, and the error; and
retrieving the result from the database based on querying the database using the updated database query.

14. The one or more non-transitory computer readable media of claim 9, wherein generating the natural language response comprises:
generating an indication of one or more columns from which the result was retrieved; and
accessing a data lineage indicating when the result was added to the database.

15. A system, comprising:
one or more processors; and
one or more memories storing a program, which, when executed on any combination of the one or more processors, performs operations, the operations comprising:
receiving a natural language request for information contained in a database;
identifying, based on the natural language request and a natural language meta-schema for the database, a relevant schema comprising:
a subset of tables from a plurality of tables of the database, wherein the subset of tables excludes at least one table of the plurality of tables and is identified based on a first plurality of natural language labels for the plurality of tables,
a subset of columns from a plurality of columns in the subset of tables, wherein the subset of columns excludes at least one column of the plurality of columns and is identified based on a second plurality of natural language labels for the plurality of columns, and
a subset of values from a plurality of values in the subset of columns, wherein the subset of values excludes at least one value of the plurality of values and is identified based on semantic indices for the plurality of values;
generating a database query based on prompting one or more language models (LMs) using the relevant schema and the natural language request;
retrieving a result from the database using the database query; and
generating a natural language response to the natural language request based on the result and using the one or more LMs.

16. The system of claim 15, further comprising:
generating the natural language meta-schema based on:
generating the first plurality of natural language labels for the plurality of tables; and
generating the second plurality of natural language labels for the plurality of columns; and
vectorizing the plurality of values to generate the semantic indices.

17. The system of claim 15, wherein identifying the relevant schema comprises:
identifying the subset of tables based on filtering the plurality of tables based on the natural language request;
identifying the subset of columns based on filtering columns from the subset of tables based on the natural language request; and
identifying the subset of values based on filtering values from the subset of columns based on the natural language request.

18. The system of claim 15, wherein identifying the relevant schema comprises:
identifying the subset of values based on identifying values, of the plurality of values, matching the natural language request;
identifying the subset of columns based on identifying columns containing the subset of values; and
identifying the subset of tables based identifying tables containing the subset of columns.

19. The system of claim 15, wherein retrieving the result from the database using the database query comprises:
receiving an error in response to querying the database using the database query;
generating an updated database query based on prompting the one or more LMs using the relevant schema, the natural language request, and the error; and
retrieving the result from the database based on querying the database using the updated database query.

20. The system of claim 15, wherein generating the natural language response comprises:
generating an indication of one or more columns from which the result was retrieved; and
accessing a data lineage indicating when the result was added to the database.
